(19) United States
(12) Patent Application Publication
(10) Pub. No.: US 2016/0377731 A1
(43) Pub. Date: Dec. 29, 2016

(54) DETECTION OF PARKING LOT CONTEXT

(71) Applicant: QUALCOMM Technologies International, Ltd., Cambridge (GB)

(72) Inventors: Vivek Garg, Haryana (IN); Madhukar Ramamurthy, Karnatka (IN)

(21) Appl. No.: 14/753,408

(22) Filed: Jun. 29, 2015

(51) Int. Cl. G01S 19/42; G01S 19/24

(52) U.S. Cl. CPC G01S 19/42; G01S 19/24

(57) ABSTRACT

The system provides a global navigation satellite system (GNSS) receiver in a vehicle including a radio frequency (RF) receiving circuit for receiving GNSS signals from a plurality of GNSS satellites orbiting Earth at different elevations, and a processor. The processor is configured to calculate a first signal to noise ratio (SNR) for a first GNSS satellite, calculate a second SNR for a second GNSS satellite, monitor a relative change in the first SNR with respect to the second SNR over time, determine that the GNSS receiver has entered a parking garage based on the relative change in the first SNR with respect to the second SNR, in response to this determination, restrict a positioning algorithm to estimate the position of the vehicle upon the vehicle exiting the parking garage to be within a specified range of a known position of an entrance of the parking garage.

This application relates, in general, to a system and a method for determining a position of a global navigation satellite system (GNSS) receiver located in a vehicle. More specifically, this application relates to determining when the vehicle is located in a parking garage. When the vehicle leaves the parking garage, the system restricts the estimated GNSS position fix of the vehicle to be within a range of the parking garage entrance or exit.

### BACKGROUND

Conventional GNSS receivers that are placed in vehicles are able to determine the position of the vehicle by receiving GNSS signals from GNSS satellites. These conventional GNSS receivers may also be equipped with dead-reckoning capabilities that track the vehicle position when adequate GNSS signals cannot be received.

However, these conventional systems do not determine and utilize positional context information (e.g. information indicating that the vehicle is in a parking garage, tunnel, etc.) This deficiency of context information leads to drawbacks such wasted power consumption, for example, by attempting to compute a GNSS position fix when GNSS signals are not usable such as in a tunnel scenario, or by computing a GNSS position fix having significant positional error due to estimating position based on low SNR GNSS signals (e.g. parking garage scenario).

### SUMMARY

To meet this and other needs, and in view of its purposes, the described system includes a global navigation satellite system (GNSS) receiver in a vehicle, including a radio frequency (RF) receiving circuit configured to receive GNSS signals from a plurality of GNSS satellites orbiting Earth at different elevations, and a processor. The processor is configured to calculate a first signal to noise ratio (SNR) of the received GNSS signals for a first GNSS satellite of the plurality of GNSS satellites, calculate a second SNR of the received GNSS signals for a second GNSS satellite of the plurality of GNSS satellites, monitor a relative change in the first SNR with respect to the second SNR over time, determine that the GNSS receiver has entered a parking garage at an entrance based on the relative change in the first SNR with respect to the second SNR, in response to determining that the GNSS receiver is located in the parking garage, restrict a positioning algorithm to estimate the position of the vehicle upon the vehicle exiting the parking garage to be within a specified range of a known position of the entrance of the parking garage, and execute the restricted positioning algorithm to estimate a position of the GNSS receiver based on the received GNSS signals.

Also includes is a method for estimating position of a global navigation satellite system (GNSS) receiver. The method includes receiving, by a radio frequency (RF) receiving circuit, GNSS signals from a plurality of GNSS satellites orbiting Earth at different elevations, calculating, by a processor, a first signal to noise ratio (SNR) of the received GNSS signals for a first GNSS satellite of the plurality of GNSS satellites, calculating, by the processor, a second SNR of the received GNSS signals for a second GNSS satellite of the plurality of GNSS satellites, monitoring, by the processor, a relative change in the first SNR with respect to the second SNR over time, determining, by the processor, that the GNSS receiver has entered a parking garage at an entrance based on the relative change in the first SNR with respect to the second SNR over time, in response to determining that the GNSS receiver has entered the parking garage, restricting, by the processor, a positioning algorithm to estimate the position of the vehicle upon the vehicle exiting the parking garage to be within a specified range of a known position of the entrance of the parking garage, and executing, by the processor, the restricted positioning algorithm to estimate a position of the GNSS receiver based on the received GNSS signals.

Also included is a mobile phone including a radio frequency (RF) receiving circuit configured to receive GNSS signals from a plurality of GNSS satellites orbiting Earth at different elevations, and a processor. The processor is configured to calculate a first signal to noise ratio (SNR) of the received GNSS signals for a first GNSS satellite of the plurality of GNSS satellites, calculate a second SNR of the received GNSS signals for a second GNSS satellite of the plurality of GNSS satellites, monitor a relative change in the first SNR with respect to the second SNR over time, determine that the GNSS receiver has entered a building at an entrance based on the relative change in the first SNR with respect to the second SNR over time, in response to determining that the GNSS receiver has entered the building, restrict a positioning algorithm to estimate the position of the mobile phone upon the mobile phone exiting the building to be within a specified range of a known position of the entrance of the building, and execute the restricted positioning algorithm to estimate a position of the GNSS receiver based on the received GNSS signals.

It is understood that the foregoing general description and the following detailed description is exemplary, but not restrictive.

### BRIEF DESCRIPTION OF THE DRAWINGS

FIG. 1. is a drawing of hardware for a GNSS receiver, according to an example embodiment.

FIG. 2 is a drawing of hardware for a Smartphone/In-Vehicle device that includes the GNSS receiver in FIG. 1, according to an example embodiment.

FIG. 3 is a top view of a parking garage, according to an example embodiment.

FIG. 4 is a side view of a parking garage, according to an example embodiment.

FIG. 5 is data plot simulation of signal to noise ratio (SNR) versus time of week (TOW) for low, medium and high elevation satellites while the vehicle is traveling from an open sky into the parking garage, according to an example embodiment.

FIG. 6 is data plot simulation of SNR for low, medium and high elevation satellites while the vehicle is in open sky, according to an example embodiment.

FIG. 7 is data plot simulation of SNR for low, medium and high elevation satellites while the vehicle is in a parking garage, according to an example embodiment.

FIG. 8 is a drawing of a comparison of between the position estimate of the GNSS receiver using an unrestricted positioning algorithm, and the position estimate of the GNSS receiver using a positioning algorithm restricted based on the position of the parking garage entrance/exit, according to an example embodiment.

FIG. 9 is a flowchart of a method for estimating a position of the GNSS receiver in a parking garage scenario, according to an example embodiment.

### DETAILED DESCRIPTION

As described below, the example embodiments provide a system and a method for determining context information (e.g. identification of a parking garage environment) related to the position of a Global Navigation Satellite System (GNSS) receiver that may be located in a vehicle. In one example, the GNSS receiver may be integrated into a Smartphone or other In-Vehicle device (e.g. Tablet Computer) that may be in the possession of the user (e.g. the driver/passenger of the vehicle). In another example, the GNSS receiver may be integrated into an In-Vehicle device such as a computer system (e.g. navigation/communication system) internal to the vehicle for providing turn-by-turn directions to the driver.

In general, a GNSS receiver, such as a global positioning satellite (GPS) receiver, is a navigation system which determines its position (and therefore the position of the vehicle or mobile phone) by measuring the arrival time of signaling events received from multiple satellites in Earth's orbit. Each satellite transmits a navigation message containing the time when the message was transmitted and ephemeris information which includes details about the satellite's orbit and corrections for the satellite's clock, in comparison with a universal or absolute time such as GNSS time. The ephemeris and clock correction parameters may collectively be known as ephemeris information. From the orbit information, the GNSS receiver can determine the elevation (i.e. angle of the satellite position with respect to the horizon) of each satellite. For example, high elevation satellites may be considered any satellite 60 degrees to 90 degrees above the horizon, medium elevation satellites may be considered any satellite 30 degrees to 60 degrees above the horizon, and low elevation satellites may be considered any satellite 0 degrees to 30 degrees above the horizon. The angle ranges for the high, medium and low elevation satellites may be pre-programmed into the GNSS receiver, or may be dynamically changed depending on current GNSS conditions. In one example, the GNSS receiver may determine the spatial distribution of the visible satellites with respect to the horizon (e.g. based on the orbit information contained in the ephemeris information), and then sort each of the visible satellites into one of the three categories (i.e. high, medium and low).

GNSS signals may be formed of a navigation message binary phase shift modulated (BPSK) onto a direct sequence spread spectrum signal. The spread spectrum signal comprises a unique pseudo-noise (PN) code that may identify each satellite. The code sequence may repeat itself, for example, every millisecond. Code sequence has an identified start instant when the two code generators in the satellite transition to the all-state. This instant is known as the code epoch. After various transport delays in the satellite, the code epoch is broadcast. This event is called a signaling event and can be recognized, in suitably adapted GNSS receivers, through a process of aligning a replica-code in the GNSS receiver with a code received from each satellite.

In addition to the time and ephemeris information, the data message may also contain satellite constellation almanac, parameters representing the ionosphere and troposphere delay, Doppler shift, health parameters and other information used by some GNSS receivers.

As mentioned above, the GNSS receiver may determine a time of arrival (TOA) of a signaling event through a process of aligning a replica-code with the code received from each satellite. The GNSS receiver may also use the time of week (TOW) information contained in the navigation message to determine the time when the signaling event was transmitted. From this, the GNSS receiver can determine the time for the signaling event (from which it can determine the distance between it and the satellite), together with the position of the satellite at the time when the signaling event was transmitted (using the ephemeris information). The GNSS receiver then can calculate its own position fix estimate.

Theoretically, the position of the GNSS receiver can be determined using signals from three satellites. However, in practice, GNSS receivers use signals typically from four or more satellites to accurately determine three-dimensional location solution and an accurate time value due to a bias between the GNSS receiver clock and the GNSS time.

Prior to calculating its own position fix estimate, the GNSS receiver, according to an embodiment, monitors the signal to noise ratio (SNR) of a plurality of satellites, including a first high elevation satellite, a second medium elevation satellite, and a third low elevation satellite to determine when the GNSS receiver (and therefore the vehicle) is located in a particular context situation such as a parking garage. In response to determining that the vehicle is located in the parking garage, for example, the GNSS receiver may restrict a position fix of the vehicle estimated by the GNSS receiver. This position fix estimate is restricted to an area in close proximity to a known position of an entrance and/or exit of the parking garage.

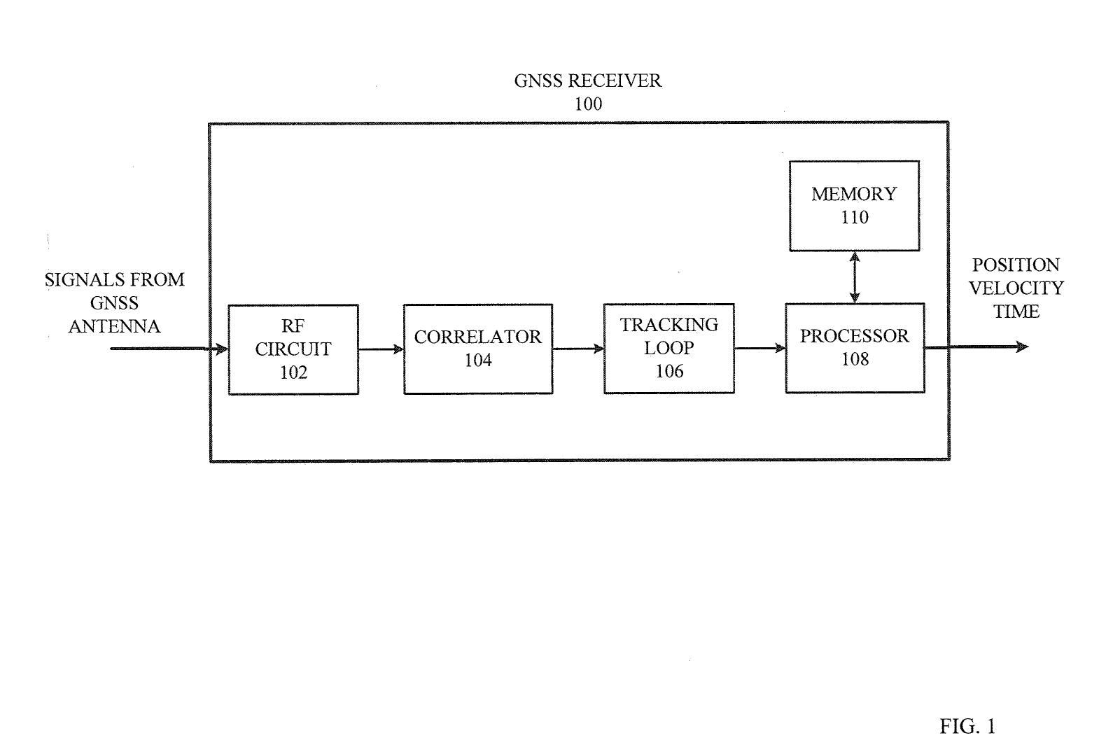

Shown in FIG. 1 is a structure of a GNSS receiver 100 that includes a radio frequency (RF) circuit 102, correlator 104, tracking loop 106, processor 108 and memory 110. Although not shown in FIG. 1, the RF circuit is connected to, and receives signals from, a GNSS antenna. The RF circuit may perform RF functions such as down-converting the transmitted RF signal so that it may be processed by correlator 104.

Given the identification of the satellite, the GNSS receiver knows the code being transmitted by the satellite, and therefore attempts to acquire the signal. After the signal is acquired, the GNSS receiver tracks changes in the signal over time. To acquire a signal a GNSS receiver may generate a replica-code and attempt to align it with the incoming received code by sliding the replica-code in time and computing the correlation in correlator 104. The output of correlator 104 is then input to tracking loop 106 which may be implemented as a delay lock-loop which continuously adjusts the replica-code to keep it aligned with the code in the incoming signal. After alignment is accomplished, the code may be removed from the signal leaving the carrier modulated by the navigation message.

This signal may then be tracked with a phase lock-loop in tracking loop 106. Since the track code is generated at instances in accordance with the satellite clock, the GNSS receiver can read the satellite clock time to determine when the code was generated and then utilize the computed time at the GNSS receiver to determine when the code was received. Multiplying the apparent transit time by the speed of light gives the pseudoranges of the satellites. These pseudo-ranges are then passed to processor 108 which implements a positioning algorithm (e.g. Kalman Filter, Least Squares Estimation, etc.) to compute the position, velocity and time of GNSS receiver 100. Processor 108 may be programmed with software code residing in memory 110 that instructs the processor on how to utilize the pseudoranges and rate measurements in order to compute the position of the GNSS receiver 100.

In an example, processor 108 may utilize code from memory 110 to estimate the position, velocity and time of GNSS receiver 100 by using a least squares estimation based on the computed pseudo-ranges. In another example, processor 108 utilizes code from memory 110 to implement a Kalman filter that estimates the position, velocity and time of the GNSS receiver by using a time series of pseudo-range measurements and optional dead reckoning sensors. In either scenario, the estimated position of GNSS receiver 100 may then be output by processor 108 to the navigation system of the vehicle (i.e., assuming the GNSS receiver is integrated within the vehicle), or to other components of a mobile device (i.e., assuming the GNSS receiver is integrated in the mobile device such as a Smartphone or Tablet).

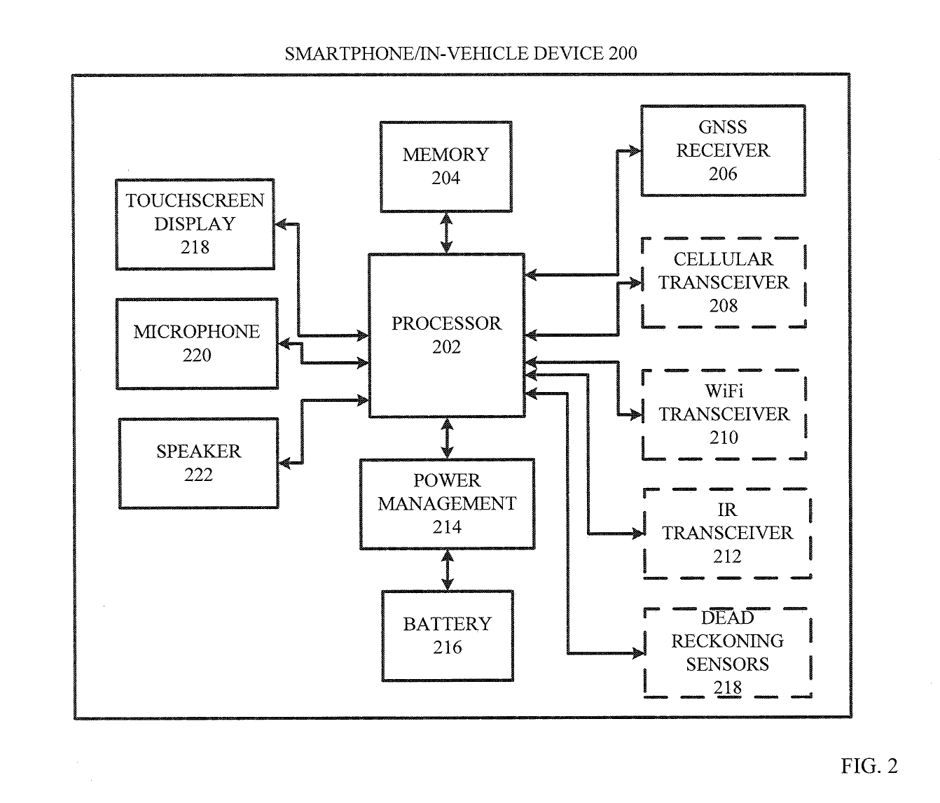

In one example, as shown in FIG. 2, the GNSS receiver 100 from FIG. 1 may be integrated into a Smartphone/In-Vehicle device 200 as GNSS receiver 206. Smartphone/In-Vehicle device 200 may include hardware processor 202, memory device 204, power management system 214, battery 216, touch screen display 218, microphone 220, speaker 222, optional cellular transceiver 208, optional Wi-Fi transceiver 210, optional IR receiver 212, optional dead reckoning sensors 218, among others.

As described above, Smartphone/In-Vehicle device 200 may be a Smartphone, or an In-Vehicle device which may be integrated into the vehicle (e.g. Vehicle Navigation/Communication System), or may not be integrated in the vehicle (e.g. External Navigation Device, Tablet Computer, etc.). Although not dispositive, the implementation of Smartphone/In-Vehicle device 200 may determine the inclusion/exclusion of the optional components in FIG. 2.

The following examples are for illustration purposes. In a first example, the optional cellular transceiver 208, Wi-Fi transceiver 210, IR receiver 212 and dead reckoning sensors 218 (e.g. accelerometer and/or gyroscope) may be included when Smartphone/In-Vehicle device 200 is a Smartphone or other mobile device such as a Tablet computer. In a second example, optional dead reckoning sensors 218 (e.g. accelerometer, steering angle sensor, wheel speed sensor, compass, inclination sensor, brake sensor, light sensor, sound sensor, altitude sensor, etc.) and possibly the optional cellular transceiver 208, may be included when Smartphone/In-Vehicle device 200 is a system integrated into the internal navigation/communication system of the vehicle.

In either example described above, processor 202 controls the various components within Smartphone/In-Vehicle device 200. Memory 204 may include software and other data stored for access by processor 202. Power management system 214 may include a power circuit for ensuring that the voltage supplied by battery 216 is of adequate quality for processor 202 and the other components within Smartphone/In-Vehicle device 200. Touch screen display 218 may allow the user to interact with the Smartphone/In-Vehicle device 200. In addition, microphone 220 may allow the user to speak into the Smartphone/In-Vehicle device, and speaker 222 may allow the Smartphone/In-Vehicle device to output audio to the user.

In addition to GNSS receiver 206, the Smartphone/In-Vehicle device 200 may also include optional cellular transceiver 208, optional Wi-Fi transceiver 210, and optional IR transceiver 212 for receiving wireless communications via cellular RF transmissions, Wi-Fi transmissions and IR transmissions respectively. These three transceivers may allow Smartphone/In-Vehicle device 200 to both transmit and receive signals from other wireless devices using various wireless communication formats. In addition to these transceivers, dead reckoning sensors (e.g. accelerometer, gyroscope, steering angle sensor, wheel speed sensor, compass, etc.) may be included. These sensors may be used on their own, or in conjunction with the GNSS receiver to estimate the vehicle position.

The system and method described in the application may be utilized in various scenarios such as a parking garage scenario or any building scenario where satellites signals may be blocked from reception at the GNSS receiver. For example, the system may be utilized in a Smartphone carried by a user that is walking through a building such as an office building. However, for simplicity sake, the hereafter described examples are directed to a parking garage scenario where a vehicle includes a GNSS receiver (i.e., either integrated into the vehicle itself or integrated into a Smartphone carried by a passenger/driver). The system determines that the vehicle has entered the parking garage, monitors the SNR of satellite signals transmitted from low, medium and high elevation satellites, and then restricts the position estimate of the vehicle upon exiting the parking garage.

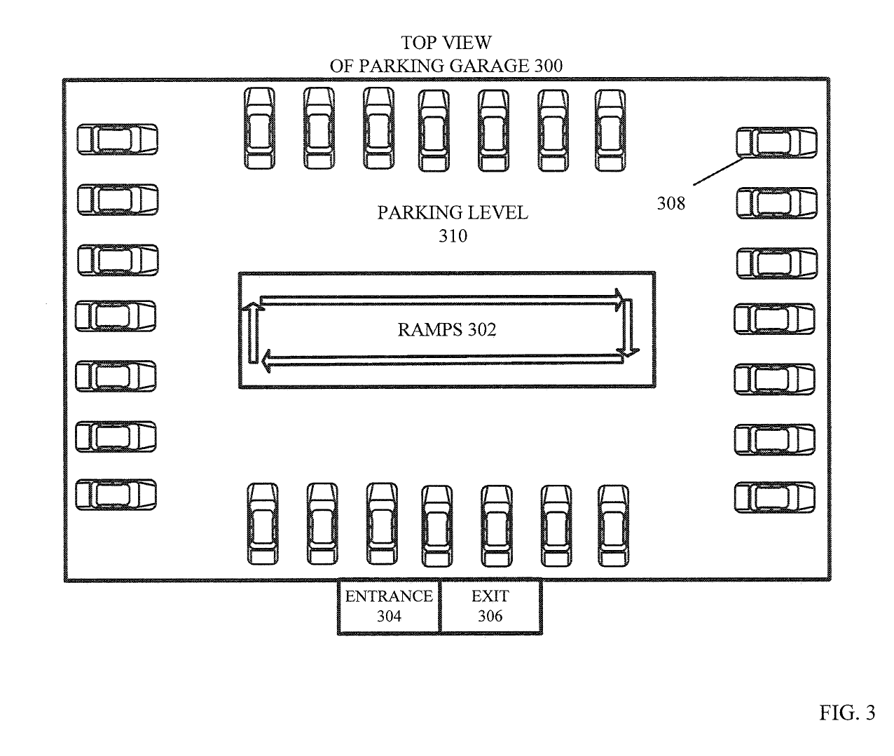

Shown in FIG. 3 is an example of a top view of a parking garage 300. It is known that parking garages typically include multiple (N) levels, where N is an integer number. The view of FIG. 3, however, for simplicity sake, is of a single parking level 310 within the garage 300 that includes numerous vehicles 308 parked in parking spaces.

In practice, the vehicle would enter the parking garage through entrance 304. The driver of the vehicle would then attempt to locate a vacant parking space to park the vehicle. If a vacant parking space is not available on the first level, then the driver navigates the vehicle (e.g. vertically) through the parking garage to upper levels using ramps 302. Ramps 302 may be configured in a somewhat circular manner allowing the vehicles to traverse different levels (i.e., go up and go down) in the parking garage. Similarly, when a driver returns to their parked vehicle, they may wish to exit the parking garage. This is performed in a similar manner in that the vehicle traverses downward in the parking garage using ramps 302 and exits through exit 306.

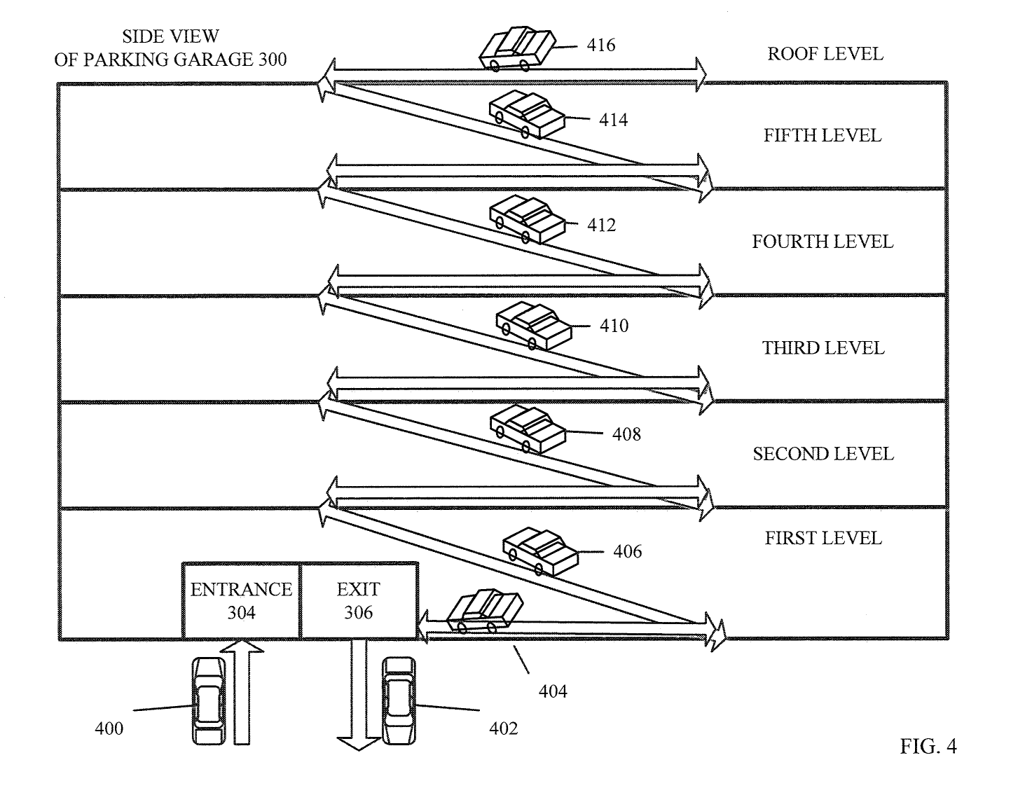

For more clarity of the vehicle traversing different levels in the parking garage 300, FIG. 4 shows a side view of parking garage 300 that includes six different levels (i.e., first level, second level, third level, fourth level, fifth level and roof level). Parking garage 300 also shows entrance 304 for allowing vehicles to enter the garage, and exit 306 for allowing vehicles to exit the garage.

In general, vehicle 400 may enter parking garage 300 via entrance 304 and traverse from the first level up to the roof level if necessary using the ramp system 302. Similarly, a vehicle may leave the parking garage 300 by traversing from an upper level down to the first level using ramp system 302, and then exit the parking garage 300 using exit 306.

In order to determine that the vehicle has entered parking garage 300, the GNSS receiver monitors the signal to noise ratio (SNR) of the satellites transmitting the GNSS signals. Specifically, the GNSS receiver separately monitors the SNR for high elevation satellites (90 degrees to 60 degrees), medium elevation satellites (60 degrees to 30 degrees) and low elevation satellites (less than 30 degrees). The GNSS receiver is then able to compare the SNR values of the high elevation satellites, medium elevation satellites and low elevation satellites to each other in order to determine if the vehicle is in an open sky scenario or is located in a parking garage.

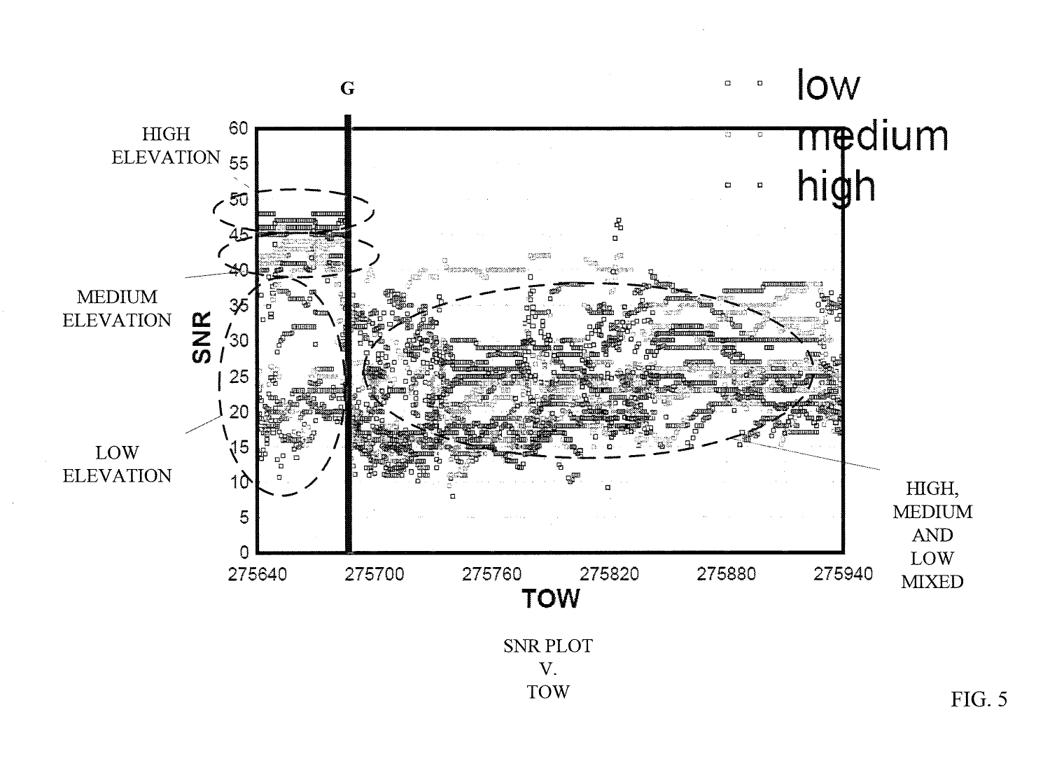

Shown in FIG. 5 is a data simulation showing comparison plot of SNR for low, medium and high elevation satellites with respect to time in both an open sky scenario and a garage scenario. The vehicle is shown to transition from the open sky scenario to the garage scenario at point G. Specifically, between time 275640 and transition line G, the vehicle (and thus a GNSS receiver) is in an open sky scenario. For example, the vehicle may be traveling down a street or a highway where the signals from the high, medium and low elevation satellites are received without obstruction of an overhead structure. It is shown, in this open sky scenario between time 275640 and line G, that the high elevation satellites have the highest average SNR, the medium elevation satellites have the second highest average SNR and the low elevation satellites have the lowest average SNR as measured by the GNSS receiver. The SNR measurements for the high, medium and low evaluation satellites are clearly separate from each other as shown by the three ellipses in FIG. 5.

However, as shown by transition line G, when the vehicle enters a parking garage, the average SNR of both the high elevation satellites and the medium elevation satellites drops significantly such that the SNR measurements of all three elevation satellites are mixed together as shown by the large ellipse in FIG. 5. Thus, from time point G to time point 275640, the SNR of all three types of satellites are mixed together because the GNSS signals (especially the signals transmitted from the high and medium elevation satellite) are being blocked by the parking garage structure.

The loss of SNR for the high elevation and medium elevation satellites is due the parking lot structure (e.g., the concrete ceilings and pathways) blocking a significant amount of the overall GNSS signal power. The SNR of the low elevation signals of the low elevation satellites is not significantly impacted since parking garages typically include side openings (e.g. open to the sky) on each level which allows the signals from the low elevation satellites to reach the GNSS receiver.

It should also be noted that the SNR of signals observed from the satellites is also dependent on the altitude of the antenna of the GNSS receiver. As the altitude of the GNSS receiver antenna increases, the line of sight to the GNSS receiver antenna becomes less obstructed. The low elevation satellites may be observed to have higher SNRs than the high elevation satellites when the antenna of the GNSS receiver is at higher altitudes than when the antenna is at lower altitudes.

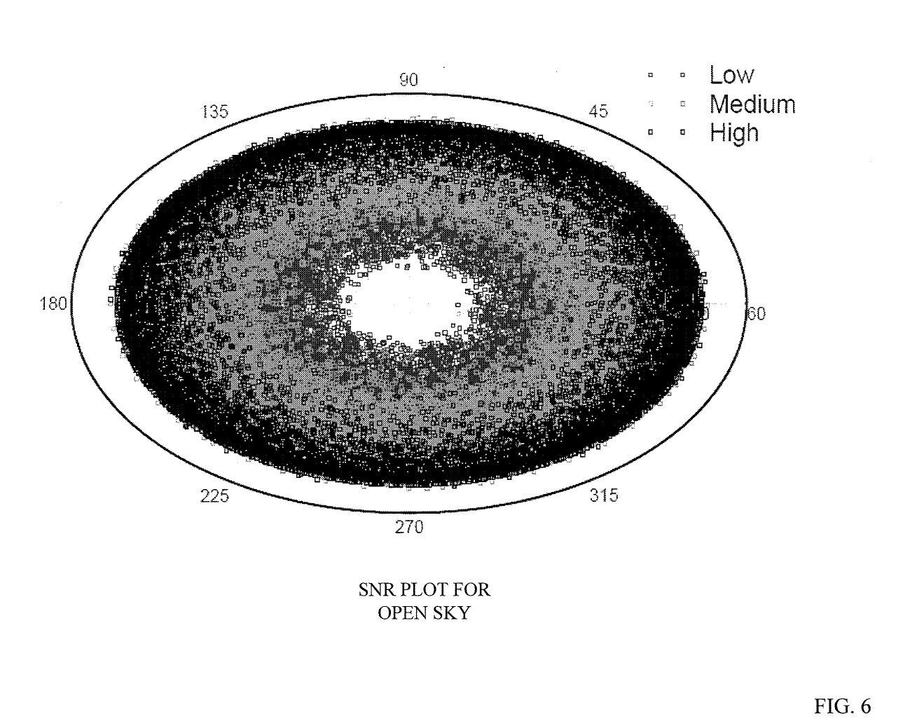

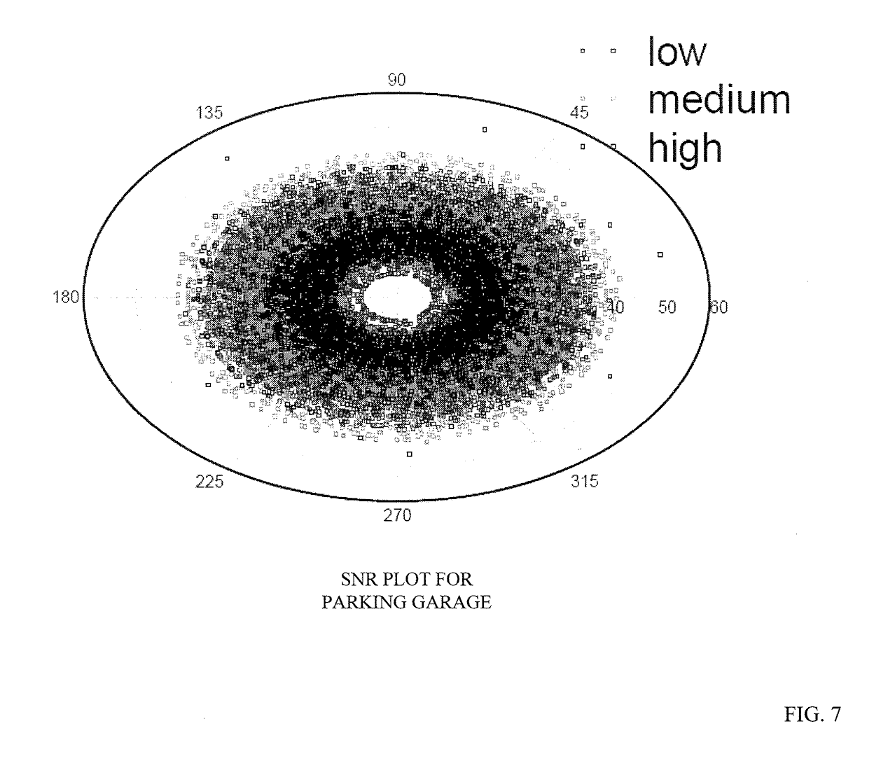

Further confirmation of the relationship between the satellite signal SNR values of the low, medium and high elevation satellites is shown in FIGS. 6 and 7 for an open sky and garage scenario respectively. Specifically, FIG. 6 shows an SNR plot where the angle represents the passage of time, and the distance from the center of the plot indicates the absolute value of SNR of the signal being received from the low, medium and high elevation satellites. It is clear from FIG. 6 that in the open sky scenario, the SNR of the signals received from the high elevation satellites is the highest, the SNR for the signals received from the medium elevation satellites is second highest, and the SNR for the signals received from the low elevation satellites is the lowest. This relationship corresponds to the SNR value relationship shown in FIG. 5 between time point 275640 and line G (i.e. open sky scenario).

However, once the vehicle has entered the parking garage, the SNR for the signals received from the high elevation satellites substantially decreases as shown in FIG. 7. It is also shown that the SNR for the signals received from the medium elevation satellites has also decreased since the vehicle has entered the parking garage. This relationship corresponds to the SNR value relationship shown in FIG. 5 between transition line G and time 27940 (i.e. garage scenario).

During operation, the GNSS receiver measures the SNR of the signals received from the low, medium and high elevation satellites, and monitors both the absolute value SNR values and their relationship with respect to each other to determine if the vehicle is in an open sky scenario or has entered a parking garage. This determination gives the GNSS receiver context information (i.e. the receive knows it is located in a parking garage) that may be used to better obtain a more accurate position fix of the vehicle once the vehicle exits the parking garage.

An example of the operation of the GNSS receiver system will now be described with reference to FIG. 4. In one example, assume vehicle 400 is traveling on a roadway in an open sky scenario. In this open sky scenario, the SNR values of the received satellite signals may appear similar to those shown in the plot of FIG. 6. However, once vehicle 400 enters the parking garage through entrance 304, the signals from both the high and medium elevation satellites become partially blocked by the parking structure and therefore their SNR values significantly decrease.

The GNSS receiver determines that the absolute values of the SNR values have decreased for signals received from the high and medium elevation satellites, and may also determine that the SNR values of the signals received from the high and medium elevation satellites are now comparable to the SNR values of the signals received from the low elevation satellites. It is at this point in time that the GNSS receiver may suspect that the vehicle has entered a parking garage. In response to this change in SNR, the GNSS receiver may store the last known position fix (i.e. prior to the SNR decreasing). This last known position fix will likely be located close to entrance 304. Knowing that the last known position fix likely corresponds to the location of entrance 304, the GNSS receiver may store this information for later use.

Now consider the scenario where vehicle 400 travels from the first level of the parking garage, up to the roof level of the parking garage in order to find a vacant parking spot. As vehicle 400 traverses through the first level of the parking garage (e.g., at position 404), the SNR of the signals received from the high and medium elevation satellites are low. Assuming the vehicle moves from position 404 to positions 406, 408, 410, 412, 414, 416 via ramp system 302 to find a parking space, the SNRs of the signals received from the low, medium and high elevation satellites may change. It is with this absolute and relative change in SNR that the vehicle may further be able to confirm that it is located in a parking garage.

Specifically, as the vehicle travels vertically upwards in the parking garage from the first level to the roof level, the GNSS receiver continues monitoring the SNR values of the signals received from the low, medium and high elevation satellites. At the low levels of the parking garage (e.g., first level), the average SNR of the signals received from the medium elevation satellites and the low elevation satellites may be greater than the average SNR of the signals received from the high elevation satellites (similar to those shown in FIG. 7). As the vehicle travels upwards in the parking garage to the second, third, fourth and fifth levels, the average SNR of the signals received from the low elevation satellites increases, the average SNR of the signals received from the medium elevation satellites decreases, (i.e. the SNR of the low and medium elevation satellites have an inverse relationship over time as the vehicle travels upward) and the average SNR of the signals received from the high elevation satellites stays relatively constant.

For example, when the vehicle first enters the parking garage, the SNR of the signals received from the high elevation satellites is drastically decreased, due to being blocked by the parking structure, which indicates that the vehicle has entered a structure with a roof (e.g. parking garage). As the vehicle traverses upwards in the parking garage to higher levels, the average SNR of the signals received from the low elevation satellites increase due to signals being received from openings in the parking garage structure (e.g. openings in the concrete structure that allow RF signals to enter the parking garage), whereas the SNR of the signals received from the medium elevation satellites decrease due to the signals being blocked by the parking garage structure. This change in absolute SNR information and relative SNR information between the low and medium elevation satellites is utilized by the GNSS receiver to further confirm that the vehicle is located in the parking garage scenario and traversing upwards. It is noted that once the vehicle reaches position 416 on the roof level of the parking garage, then the average SNR of the signals received from the high elevation satellites once again are the highest since the roof is an open sky situation similar to FIG. 6.

When the vehicle traverses downwards from position 416 to position 404 (i.e., when the driver wants to exit the parking garage), the GNSS receiver notices the opposite effect as when the vehicle was traversing upwards in the garage. For example, the GNSS receiver notices that the average SNR of the signals received from the low elevation satellites decreases and the average SNR of the signals received from the medium elevation satellites increases as the vehicle goes down the ramp system 302 (i.e. the SNR of the low and medium elevation satellites have an inverse relationship over time as the vehicle travels downward). This change in absolute SNR information and relative SNR information between the low and medium elevation satellites is utilized by the GNSS receiver to further confirm that the vehicle is located in the parking garage scenario and traversing downwards.

Once the GNSS receiver determines that the vehicle is located in the parking garage (as described above), the GNSS receiver can use the last known position fix prior to entering the parking garage as an anchor. This anchor can be used to obtain a more accurate position fix when the vehicle exits the parking garage.

Although not described above, it should be noted that the GNSS receiver can identify other scenarios based on the SNR values of the signals received from the high, medium and low elevation satellites. For example, if the SNR of all satellites drops to unusable levels, and the vehicle is traveling at a high speed, the GNSS receiver may determine that the GNSS receiver is located in a tunnel (not a parking garage where some of the signals should still be visible due to the openings).

This tunnel scenario may occur in various instances, such as when the vehicle is traveling down the roadway and enters a tunnel, or when the parking garage itself transitions into a tunnel (i.e. the parking garage is attached to a tunnel). In these tunnel scenarios, the algorithm may transition to using dead reckoning when the GPS signals fall below usable levels for a certain duration of time. For example, the processor of the GNSS receiver may shut down the GNSS processing completely and strictly rely on dead reckoning in order to reduce power consumption (i.e., power is not wasted since the SNR of the satellite signals is at unusual levels).

As described above, the Smartphone/In-Vehicle device 200 may determine its position within the parking garage using one of a number of different methods (e.g. least squares estimate using the computed pseudo-ranges, Kalman Filtering using pseudo-ranges and other information over a time series, dead reckoning sensors/algorithms, etc.) Below is a description of how the position estimate of the vehicle as estimated in all three scenarios could be improved using the satellite SNR values.

In a first example, during the time in which vehicle 400 is traveling in the open sky scenario and is traversing through the parking garage, the processor 108 of the GNSS receiver may be implementing a positioning algorithm in the form of a least squares estimator, Kalman filter, etc. that uses satellite pseudo-range values to estimate the position of the vehicle. In the open sky scenario, the satellite signals are not blocked and the position estimate of the least squares estimator will be accurate. However, in the garage scenario, since the signals of the various satellites may be at least partially blocked (i.e., the received signals have low SNRs), the estimations of the least squares estimator may not be accurate.

Thus, when vehicle 402 exits through exit 306, the least squares estimator in the GNSS receiver may incorrectly estimate the position of vehicle 402. In order to obtain a more accurate estimate of the position of vehicle 402, the GNSS receiver utilizes the last known position of vehicle 400 prior to entering through entrance 304 (i.e., just before the SNR values of the high elevation satellites significantly decreased).

Since the exit of many parking garages is adjacent to the entrance of the parking garage, the GNSS receiver can utilize the last known position fix in the open sky scenario in order to constrain the estimate performed by the least squares estimator to be within an area near entrance 304 where the receiver senses that the vehicle has left the garage. This significantly increases the accuracy of the position estimate of the least squares estimator (i.e. the least squares estimator knows that the position has to be in a small area near the entrance of the garage).

In one example, when a Kalman filter is used to estimate the position of the vehicle, confidence of different states are maintained in a covariance matrix. When the position of the vehicle cannot be calculated, the confidence in the vehicles position is reduced by increasing the corresponding covariance terms in the covariance matrix. On detection of a parking lot, the confidence is not increased. On exit from the parking lot, when more GPS signals are available, the Kalman filter uses a less inflated covariance matrix which results in a more accurate position than in the case where position covariance terms are inflated.

In a second similar example, the processor 108 of the GNSS receiver may be implementing a positioning algorithm dependent on dead reckoning sensors to estimate the position of the vehicle. As described above, in the garage scenario, since the signals of the various satellites may be at least partially blocked (i.e., the received signals have low SNRs), and may not be usable. In this example, the vehicle may rely primarily or even solely on dead reckoning sensors for position estimates. Dead reckoning sensors and algorithms may introduce cumulative error in position estimates. This cumulative error increases over time and may result in erroneous position estimates. In order to overcome these errors and obtain a more accurate estimate of the position of vehicle 402, upon exit of the garage, the GNSS receiver utilizes the last known position of vehicle 400 prior to entering through entrance 304 (i.e., just before the SNR values of the high elevation satellites significantly decreased) as the last dead reckoning position estimate.

As described above, since the exit of many parking garages is adjacent to the entrance of the parking garage, the GNSS receiver can utilize the last known position fix in the open sky scenario in order to constrain the estimate performed by position algorithm to be within an area near entrance 304.

In a third similar example, the processor 108 of the GNSS receiver may implement a positioning algorithm in the form of a Kalman filter that uses a time series of pseudo-range values and possibly dead reckoning information to estimate the position of the vehicle. As described above, in the garage scenario, since the signals of the various satellites may be at least partially blocked (i.e., the received signals have low SNRs), the estimations of the Kalman filter may not be accurate. In order to obtain a more accurate estimate of the position of vehicle 402 (upon exiting the garage), the GNSS receiver utilizes the last known position of vehicle 400 prior to entering through entrance 304 (i.e., just before the SNR values of the high elevation satellites significantly decreased).

As described above, since the exit is assumed to be adjacent to the entrance of the parking garage, the GNSS receiver can utilize the last known position fix in the open sky scenario in order to constrain the estimate performed by the Kalman filter to be within an area near entrance 304. For example, as described above, the confidence in the vehicles position is reduced by increasing the corresponding covariance terms in the covariance matrix. On exit from the parking lot, when more GPS signals are available, the Kalman filter uses a less inflated covariance matrix which results in a more accurate position than in the case where position covariance terms are inflated.

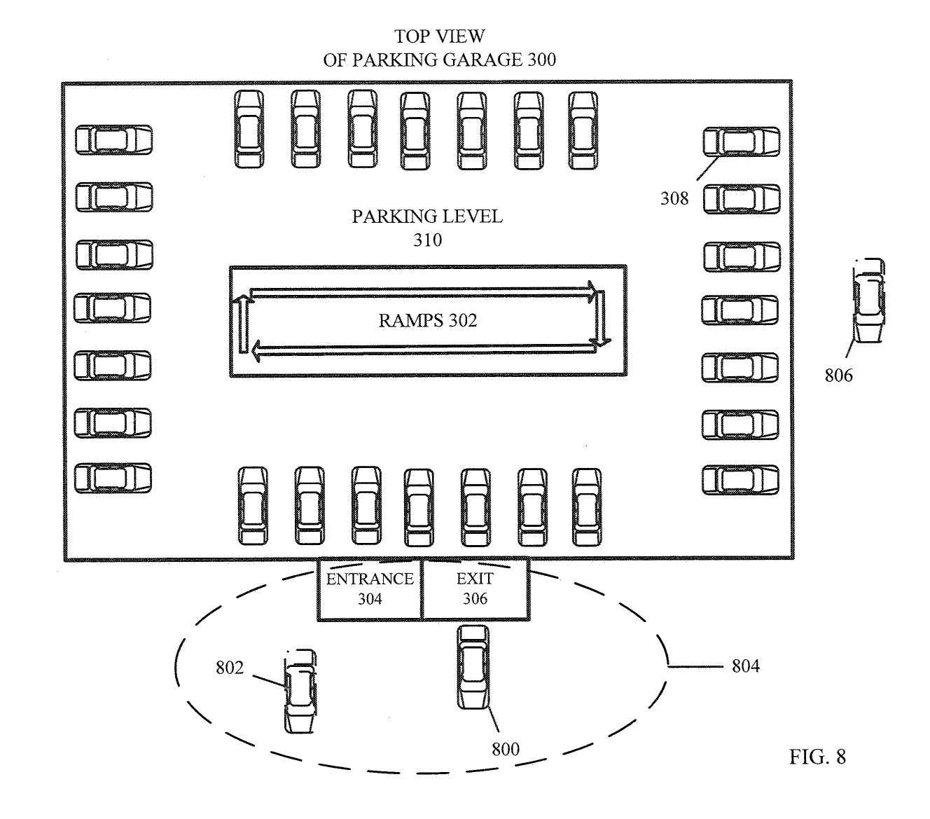

This significantly increases the accuracy of the position estimate of the Kalman filter (i.e. the Kalman Filter knows that the position has to be in a small area near the entrance of the garage). Shown in FIG. 8 is a top view of parking garage 300 similar to that shown in FIG. 3. In this example, it is assumed that vehicle 800 has already entered the parking garage 300 through entrance 304 at which point the GNSS receiver noted the last known position fix just before the SNR of the high elevation satellites dropped. It is also assumed that the GNSS receiver of vehicle 800 monitored the SNR values of the signals received from the high, low and medium elevation satellites as vehicle 800 traversed through parking garage 300 (up levels, down levels, etc.).

Now consider an example where vehicle 800 has exited through exit 306 of parking garage 300. In a conventional scenario, where context information is not known to the processor 108 of the GNSS receiver, the positioning algorithm (e.g. Kalman filter) may initially and incorrectly estimate the actual position of vehicle 800 to be position 806. As already described above, this inaccurate position estimate 806 is made by the processor 108 of the GNSS receiver because the positioning algorithm had been estimating the position of the vehicle based on low SNR satellite signals received in the parking garage, or even based solely on dead reckoning sensors if the signals where unusable.

However, since the current system monitors the SNR of the signals received from the high, medium and low elevation satellites, the GNSS receiver can determine that the vehicle is located in a parking garage and then utilize the last known accurate position fix (i.e., the position of entrance 304) as a constraint to be used in the positioning algorithm estimate. Specifically, the processor 108 of the GNSS receiver may restrict the positioning algorithm to estimating the position of vehicle 800 to be within a certain area shown by the ellipse 804. Area 804 is selected to be within a certain proximity to entrance 304 (i.e., because it is assumed that the vehicle exits through an exit that is close to entrance 304). Thus, when the positioning algorithm is constrained to area 804, the positioning algorithm is able to estimate the position of vehicle 800 to be located at position 802 which is much closer than location 806 when the positioning algorithm is not restricted.

It should be noted that there may also be scenarios where the entrance and exit of the parking garage are not placed close to each other (e.g. the entrance is on one side of the garage, while the exit is on the other side of the garage). This scenario may be detected by the vehicle when the Kalman filter estimated position on exiting the garage is determined to be a large distance from the initial position of the vehicle on entering the garage. When this scenario is detected, the Kalman filter may relax (i.e. increase) uncertainties in the current state variables, before recalculating the position of the vehicle.

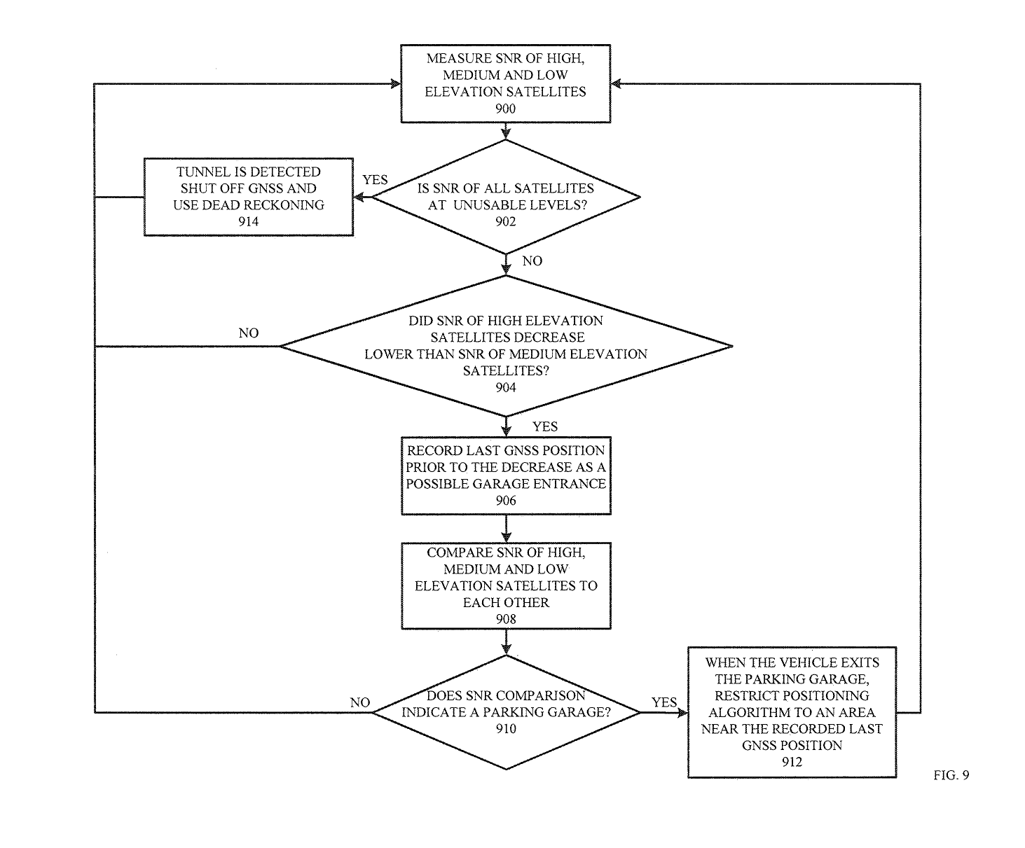

The process described above is also shown in the flow chart of FIG. 9. For example, as shown in step 900 the GNSS receiver measures the SNR of the signals received from the high, medium and low elevation satellites. In step 902, the GNSS receiver determines if the SNR of all the signals received from the satellites are at unusable levels. If the SNR of all signals received from the satellites are at unusable levels, the GNSS receiver may actually determine that the GNSS receiver is located in a tunnel (not a parking garage where some of the signals should still be visible). In this scenario, the processor of the GNSS receiver may shut down the GNSS processing and strictly rely on dead reckoning in order to consume power (i.e., power is not wasted since the SNR is at unusual levels).

However, if the SNR of some of the signals received from the satellites are at usable levels, then the GNSS receiver monitors the SNR relationship between the signals received from the high, medium and low elevation satellites. Specifically, in step 904, the GNSS receiver determines if the SNR of the signals received from the high elevation satellites has decreased to be lower than the SNR of the signals received from the medium elevation satellites. If yes, then the GNSS receiver records the last know GNSS position prior to this decrease in SNR as a possible garage entrance in step 906. Then, in step 908, the GNSS receiver compares the SNR of the signals received from the high, medium and low elevation satellites to each other as the vehicle traverses through the parking garage (e.g. up the ramps). In step 910, if it is determined that the SNR comparison indicates a parking garage, then the Kalman filter is constrained in step 912 to estimating the exit position of the vehicle to be within a certain range of the last recorded GNSS position (i.e., the position of the entrance).

Although the examples described above are in reference to a vehicle entering a parking garage, the same system and method can be utilized for a mobile phone (e.g. smartphone), or wearable (e.g. wristwatch with GNSS capabilities) of a user. In general, the algorithm described above with respect to the vehicle may be implemented by the mobile phone or the wearable to detect context (e.g. that the user is located in a building).

In one example, when a user is walking through a building, the GNSS receiver of the mobile phone (or wearable) may monitor the SNR of the signals received from the high, medium and low elevation satellites as the user enters (e.g. walks into) the building and traverses through the building up the stairway and/or elevator. In this implementation, the dead reckoning sensors of the Smartphone (or wearable) may include a pedometer. If the SNR values of the signals received from the satellites changes similarly to the example described above (e.g. due to windows in the building), then when the user exits the building, the processor 108 of the GNSS receiver can restrict the estimation of the positioning algorithm (e.g. Kalman filter) to be in an area close to the last known GNSS position (assuming the entrance and exit of the building are close to each other).

In another example, context information may be used by the mobile phone or the wearable to efficiently save power. For example, if the mobile phone or the wearable detects that that the GNSS receiver is located in a context (e.g. subway tunnel) where GNSS signals are unusable, the mobile phone or wearable may shut down the GNSS processing and strictly rely on dead reckoning in order to consume power.

It is also noted that in addition to monitoring the SNR values, the system may also monitor the motion of the vehicle and/or the person using dead reckoning sensors as the GNSS receiver traverses through the parking garage/building. The motion of the GNSS receiver in a parking garage scenario may, for example, indicate a circular, or near circular motion (e.g. rounded rectangle or oval depending on the ramp configuration) of the vehicle and low speeds as the vehicle traverses up ramp system 302 (as opposed to a tunnel where the motion will be relatively straight and at higher speeds). Similarly, the motion of the mobile phone of the user may indicate vertical motion as the user walks up stairways or travels in elevators.

It is noted that position determinations of garage entrances or other anchor points may be stored in the Smartphone/In-vehicle device as MAP data for later use, or may be shared with other Smartphone/In-vehicle devices. For example, MAP data may include identities of entrances, exits, windows, etc., of garages, buildings and other structures determined by the Smartphone/In-vehicle devices as they monitor the average SNR values of the signals received from the high, medium and low elevation satellites.

Although the system is illustrated and described herein with reference to specific embodiments, it is not intended to be limited to the details shown. Rather, various modifications may be made in the details within the scope and range of equivalents of the claims.

What is claimed:

1. A global navigation satellite system (GNSS) receiver in a vehicle, comprising:
a radio frequency (RF) receiving circuit configured to receive GNSS signals from a plurality of GNSS satellites orbiting Earth at different elevations; and
a processor configured to:
calculate a first signal to noise ratio (SNR) of the received GNSS signals for a first GNSS satellite of the plurality of GNSS satellites,
calculate a second SNR of the received GNSS signals for a second GNSS satellite of the plurality of GNSS satellites,
monitor a relative change in the first SNR with respect to the second SNR over time,
determine that the GNSS receiver has entered a parking garage at an entrance based on the relative change in the first SNR with respect to the second SNR,
in response to determining that the GNSS receiver is located in the parking garage, restrict a positioning algorithm to estimate the position of the vehicle upon the vehicle exiting the parking garage to be within a specified range of a known position of the entrance of the parking garage, and
execute the restricted positioning algorithm to estimate a position of the GNSS receiver based on the received GNSS signals.

2. The GNSS receiver of claim 1,
wherein the first GNSS satellite is a low elevation satellite, the second GNSS satellite is a medium elevation satellite, and a third GNSS satellite of the plurality of satellites is a high elevation satellite,
wherein the processor is further configured to:
compare the first SNR, the second SNR and a third SNR of the GNSS signals received from the third GNSS satellite to each other, and
determine that the GNSS receiver is located in the parking garage based on the comparison.

3. The GNSS receiver of claim 2,
wherein the processor is further configured to:
determine that the GNSS receiver is located in a parking garage when:
the comparison indicates that first SNR and the second SNR are both greater than the third SNR, or
the comparison indicates that the first SNR and second SNR have an inverse relationship with respect to each other over time.

4. The GNSS receiver of claim 1,
wherein the processor is further configured to:
determine motion of the vehicle using a time series of position estimates of the positioning algorithm or based on dead reckoning sensors, and
determine that the GNSS receiver is located in the parking garage when the motion of the vehicle indicates at least one of circular motion of the vehicle and low speed travel of the vehicle.

5. The GNSS receiver of claim 1,
wherein the positioning algorithm is implemented as a Kalman filter that includes a position restriction when estimating the position of the vehicle upon the vehicle exiting the parking garage.

6. The GNSS receiver of claim 1,
wherein the processor is further configured to:
distinguish between the parking garage and a tunnel based on the change in the first SNR, the second SNR and a third SNR for received GNSS signals of a third high elevation GNSS satellite of the plurality of satellites, and
upon determining that the GNSS receiver is located in the tunnel, suspending the positioning algorithm from estimating the position of the GNSS receiver.

7. The GNSS receiver of claim 1,
wherein the processor is further configured to:
determine and set the known position of an entrance of the parking garage based on a drop in a third SNR of signals received by a third high elevation GNSS satellite of the plurality of satellites as the vehicle enters the parking garage.

8. A method for estimating position of a global navigation satellite system (GNSS) receiver, comprising:
receiving, by a radio frequency (RF) receiving circuit, GNSS signals from a plurality of GNSS satellites orbiting Earth at different elevations;
calculating, by a processor, a first signal to noise ratio (SNR) of the received GNSS signals for a first GNSS satellite of the plurality of GNSS satellites;
calculating, by the processor, a second SNR of the received GNSS signals for a second GNSS satellite of the plurality of GNSS satellites;
monitoring, by the processor, a relative change in the first SNR with respect to the second SNR over time;
determining, by the processor, that the GNSS receiver has entered a parking garage at an entrance based on the relative change in the first SNR with respect to the second SNR over time;
in response to determining that the GNSS receiver has entered the parking garage, restricting, by the processor, a positioning algorithm to estimate the position of the vehicle upon the vehicle exiting the parking garage to be within a specified range of a known position of the entrance of the parking garage; and
executing, by the processor, the restricted positioning algorithm to estimate a position of the GNSS receiver based on the received GNSS signals.

9. The method of claim 8, further comprising:
calculating, by the processor, a third SNR of the received GNSS signals for a third GNSS satellite of the plurality of GNSS satellites;
comparing the first SNR, second SNR and the third SNR to each other over time; and
determining that the GNSS receiver is located in a parking garage based on the comparison,
wherein the first GNSS satellite is a low elevation satellite, the second GNSS satellite is a medium elevation satellite, and the third GNSS satellite is a high elevation satellite.

10. The method of claim 9, further comprising:
determining that the GNSS receiver is located in a parking garage when the comparison indicates that:
the first SNR and the second SNR are both greater than the third SNR, or
the first SNR and second SNR have an inverse relationship with respect to each other over time.

11. The method of claim 8, further comprising:
determining motion of the vehicle using a time series of position estimates of the positioning algorithm or based on dead reckoning sensors; and
determining that the GNSS receiver is located in the parking garage when the motion of the vehicle indicates at least one of circular motion of the vehicle and low speed travel of the vehicle.

12. The method of claim 8,
wherein the positioning algorithm is implemented as a Kalman filter that includes a position restriction when estimating the position of the vehicle upon the vehicle exiting the parking garage.

13. The method of claim 8, further comprising:
distinguishing between the parking garage and a tunnel based on the change in the first SNR, the second SNR and a third SNR of the received GNSS signals for a third GNSS satellite of the plurality of GNSS satellites; and
upon determining that the GNSS receiver is located in the tunnel, suspending the positioning algorithm from estimating the position of the GNSS receiver.

14. The method of claim 8, further comprising:
determining and setting the known position of an entrance of the parking garage based on a drop in a third SNR of the received GNSS signals for a third high elevation GNSS satellite of the plurality of GNSS satellites as the vehicle enters the parking garage.

15. A mobile phone, comprising:
a radio frequency (RF) receiving circuit configured to receive GNSS signals from a plurality of GNSS satellites orbiting Earth at different elevations; and
a processor configured to:
calculate a first signal to noise ratio (SNR) of the received GNSS signals for a first GNSS satellite of the plurality of GNSS satellites,
calculate a second SNR of the received GNSS signals for a second GNSS satellite of the plurality of GNSS satellites,
monitor a relative change in the first SNR with respect to the second SNR over time,
determine that the GNSS receiver has entered a building at an entrance based on the relative change in the first SNR with respect to the second SNR over time,
in response to determining that the GNSS receiver has entered the building, restrict a positioning algorithm to estimate the position of the mobile phone upon the mobile phone exiting the building to be within a specified range of a known position of the entrance of the building, and
execute the restricted positioning algorithm to estimate a position of the GNSS receiver based on the received GNSS signals.

16. The mobile phone of claim 15,
wherein the first GNSS satellite is a low elevation satellite, the second GNSS satellite is a medium elevation satellite, and a third GNSS satellite of the plurality of satellites is a high elevation satellite,
wherein the processor is further configured to:
compare the first SNR, second SNR and the third SNR to each other over time, and
determine that the GNSS receiver is located in a building based on the comparison.

17. The mobile phone of claim 15,
wherein the processor is further configured to that the GNSS receiver is located in the building when the comparison indicates that:
the first SNR and the second SNR are both greater than a third SNR of the received GNSS signals for a third GNSS satellite of the plurality of GNSS satellites, or
the first SNR and second SNR have an inverse relationship with respect to each other over time.

18. The mobile phone of claim 15,
wherein the processor is further configured to:
determine motion of the mobile phone using a time series of position estimates of the positioning algorithm or based on dead reckoning sensors, and
determine that the GNSS receiver is located in the building when the motion of the mobile phone indicates at least one of circular motion and vertical motion.

19. The mobile phone of claim 15,
wherein the positioning algorithm is implemented as a Kalman filter that includes a position restriction when estimating the position of the mobile phone upon the mobile phone exiting the building.

20. The mobile phone of claim 15,
wherein the processor is further configured to:
determine and set the known position of an entrance or an exit of the building based on a position of the entrance or exit as indicated in map data, or based on a drop in a third SNR of the received GNSS signals for a third GNSS satellite of the plurality of GNSS satellites as the mobile phone enters the building.
